(19) United States
(12) Patent Application Publication
(10) Pub. No.: US 2012/0091119 A1
(43) Pub. Date: Apr. 19, 2012

(54) Rotatable Vessel

(75) Inventor: Adrian Lim, Springvale (AU)

(73) Assignee: ADJO DESIGNS PTY. LTD., Springvale (AU)

(21) Appl. No.: 12/905,588

(22) Filed: Oct. 15, 2010

(51) Int. Cl. A47J 27/21; B67D 7/84; B67D 7/06

(52) U.S. Cl. 219/431; 222/483; 222/166; 222/470

(57) ABSTRACT

An electric tea kettle (2) comprising a stationary base (4) and a body (6) disposed on the base (4). The body (6) has a spout (44) and defines an inner chamber (62) wherein water is boiled. The body (6) is rotatable with respect to the base (4) between an upright position suitable for filling the inner chamber (62) with water and a pouring position in which boiled water may be enabled to flow out of the inner chamber (62) through the spout (44).

### TECHNICAL FIELD

The invention relates to a vessel comprising a base and a body which is tiltable or rotatable with respect to the base. In a particular preferred aspect, the invention relates to an electric tea kettle with a body which is rotatable with respect to its base.

### BACKGROUND ART

Any discussion of documents, devices, acts or knowledge in this specification is included to explain the context of the invention. It should not be taken as an admission that any of the material forms a part of the prior art base or the common general knowledge in the relevant art in the United States of America or elsewhere on or before the priority date of the disclosure herein.

Electric tea kettles commonly used in households consist of a base with a power cord which is suitable for plugging into a power outlet, and a jug in which water is boiled when resting on the base. In order to fill the jug with water, the jug must be lifted from the base and carried by a user over to a tap or faucet. Once filled, the jug is carried back to the base with the additional weight of the water therein. The jug is then placed onto the base by the user and a button or the likes is activated in order to boil the water in the jug. Once the water is boiled, the jug is again carried away from the base and manually tilted over a mug or cup so that water is enabled to flow out through the jug's spout and into the mug. Such a task can pose significant difficulties for users, such as some elderly or disabled persons, who do not possess high levels of upper limb strength and control. Furthermore, the task may be dangerous when dealing with boiling water which may cause burns when spilt by users lacking the requisite strength and stability.

Thus, it may be advantageous to provide a new vessel which overcomes one or more of the above or other disadvantages associated with the prior art, or provides an alternative to that which is already in use.

### DISCLOSURE OF THE INVENTION

In one aspect, the invention may provide a vessel comprising: a base; and a body disposed on the base, the body comprising an inner chamber adapted to hold water therein and an outlet for allowing passage of water out of the inner chamber; wherein the body is rotatable with respect to the base between an upright position suitable for filling the inner chamber with water and a pouring position in which water may be enabled to flow out of the inner chamber through the outlet with gravity.

The body may be removable from the base. However, the body may be adapted for rotation to the pouring position without being removed from the base.

In one form, the base may comprise a channel and the body may comprise a slide portion. The slide portion may be adapted to slide back within the channel during rotation of the body towards the pouring position.

The vessel may comprise a return mechanism. Suitably, the return mechanism may be adapted to return the body from the pouring position to the upright position without assistance from a user.

The return mechanism may comprise a spring. The spring may be adapted to be compressed when the body is urged towards the pouring position and adapted to recoil when the body is released thereby causing the body to return to the upright position.

In a suitable form, the base may comprise a groove with a return bridge at its back end, and the body may comprise a downwardly projecting return member. The return member may be adapted to track within the groove towards the return bridge when the body is rotated towards the pouring position. Suitably, the spring may extend between the return member and the return bridge. Thus, rotation of the body towards the pouring position may be limited by compression of the spring between the return member and the return bridge.

The base may comprise a blocking member and the body may comprise a downwardly projecting abutment member. In order to limit backwards rotation of the body past the upright position, the abutment member may be adapted to abut against the blocking member.

The vessel may comprise a flow control mechanism. The flow control mechanism may be adapted for adjusting the flow of water out of the inner chamber through the outlet when the body is in the pouring position.

In one aspect, the flow control mechanism may be adjustable between a closed configuration in which water is prevented from flowing out of the inner chamber through the outlet when the body is in the pouring position, and a released configuration in which water is allowed to flow out of the inner chamber through the outlet when the body is in the pouring position.

The flow control mechanism may comprise an internal flow bridge within the inner chamber proximate the outlet. Suitably, the flow control mechanism may comprise a bridge control for adjusting the position of the flow bridge. The body may comprise a handle and the bridge control may comprise a button disposed on the handle.

In a suitable form, the vessel may comprise a heating mechanism for boiling water in the inner chamber. The heating mechanism may comprise a heating element located proximate the bottom of and within the inner chamber. Further, the heating mechanism may comprise electrical componentry located within the base. The electrical componentry may be adapted for electrical interconnection between the heating element and an external power source.

The outlet may be adapted for connection to one end of a hose attachment. The other end of the hose attachment may be attachable to a tap or faucet.

In a suitable form, the outlet may comprise a spout. The spout may comprise a threaded recess about its external opening. The threaded recess may enable screwable connection of the spout with the hose attachment.

The vessel may comprise a steam control mechanism for controlling the flow of steam out of the outlet during pouring.

Suitably, the vessel may comprise an electric tea kettle.

In another aspect the invention may provide a method of using an electric tea kettle, the electric tea kettle comprising a base and a body which is rotatable on the base between a filling position and a pouring position, the method comprising the steps of: urging the body to rotate to the pouring position without lifting the body off the base; and, releasing the body so that it automatically rotates back to the filling position.

### BRIEF DESCRIPTION OF THE DRAWINGS

In order that the invention may be more clearly understood and put into practical effect there shall now be described in detail preferred constructions of apparatus and methods in accordance with the invention. The ensuing description is given by way of non-limitative examples only and is with reference to the accompanying drawings, wherein:

FIG. 1 is an axonometric view from above of an electric tea kettle is made in accordance with a preferred embodiment of the invention of FIG. 1,

FIG. 2 is an axonometric view from below of the electric tea kettle of FIG. 1;

FIG. 3 is a front view of the electric tea kettle of FIG. 1;

FIG. 4 is a side view of the electric tea kettle of FIG. 1;

FIG. 5 is a rear view of the electric tea kettle of FIG. 1;

FIG. 6 is a bottom view of the electric tea kettle of FIG. 1;

FIG. 7 is a top view of the electric tea kettle of FIG. 1;

FIG. 8 is a front view of the electric tea kettle of FIG. 1, shown in a filling position;

FIG. 9 is a sectional view through line A-A of FIG. 8 of FIG. 1;

FIG. 10 is a front view of the electric tea kettle of FIG. 1, shown in a pouring position;

FIG. 11 is a sectional view through line A-A of FIG. 10; and,

FIGS. 12 to 14 are a sequence of side views of the electric kettle of FIG. 1 with FIG. 12 showing the electric kettle in the filling position with a mug in place for pouring, followed by FIG. 13 wherein the kettle has been rotated into the pouring position for pouring fluid into the mug, and FIG. 14 which shows the kettle having been returned back to the filling position for filling by a preferred hose attachment.

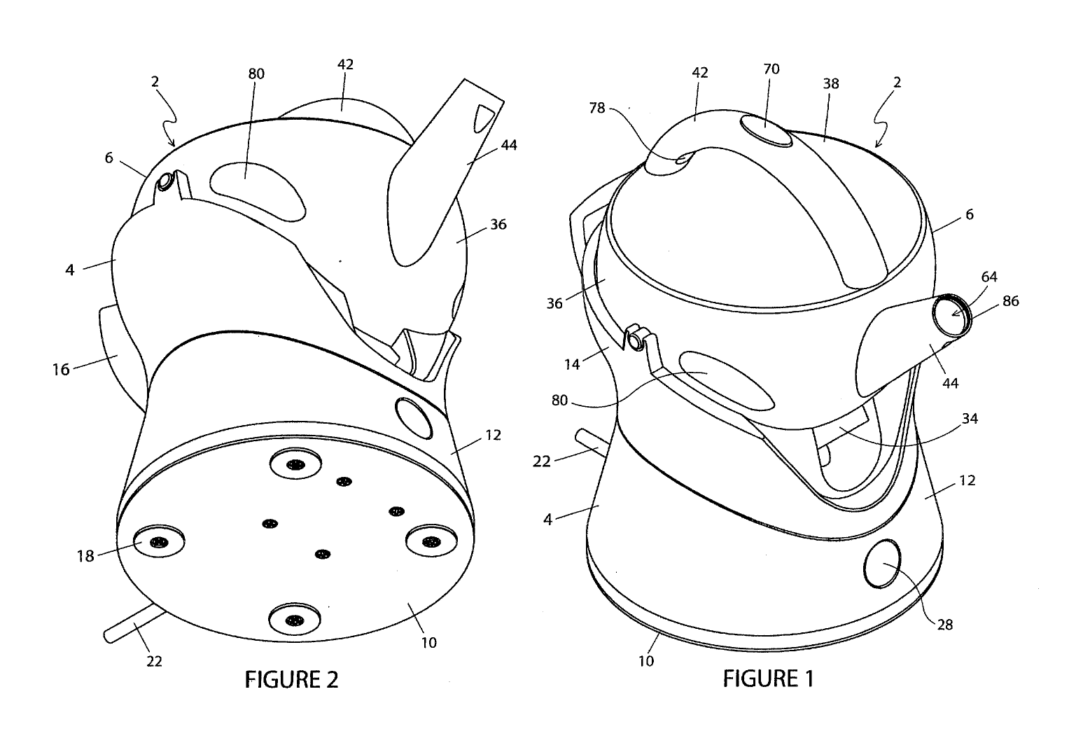

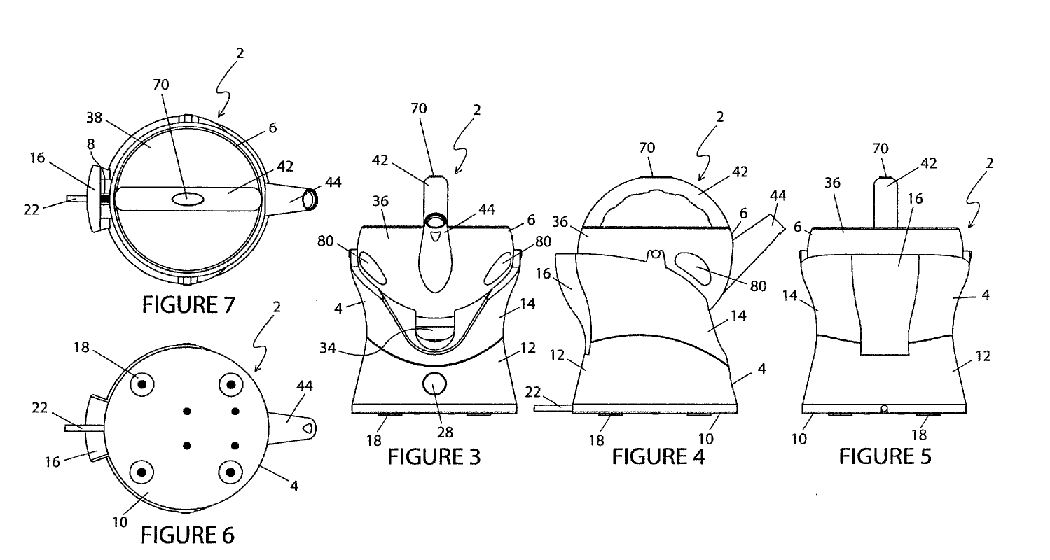

### MODES FOR CARRYING OUT THE INVENTION

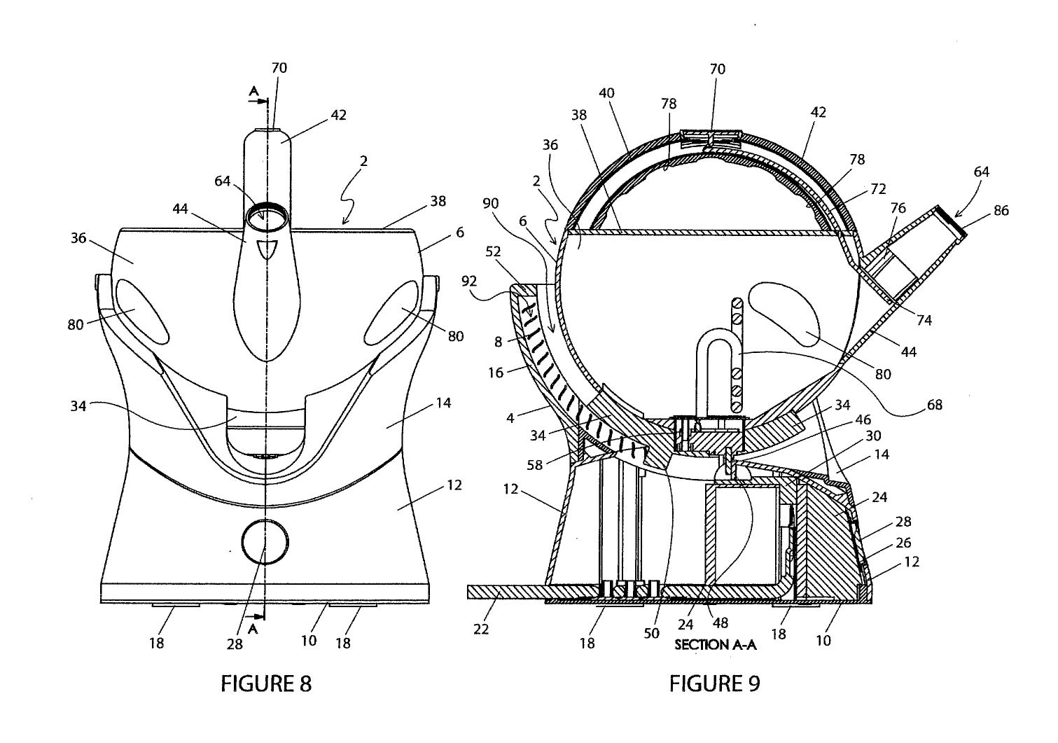

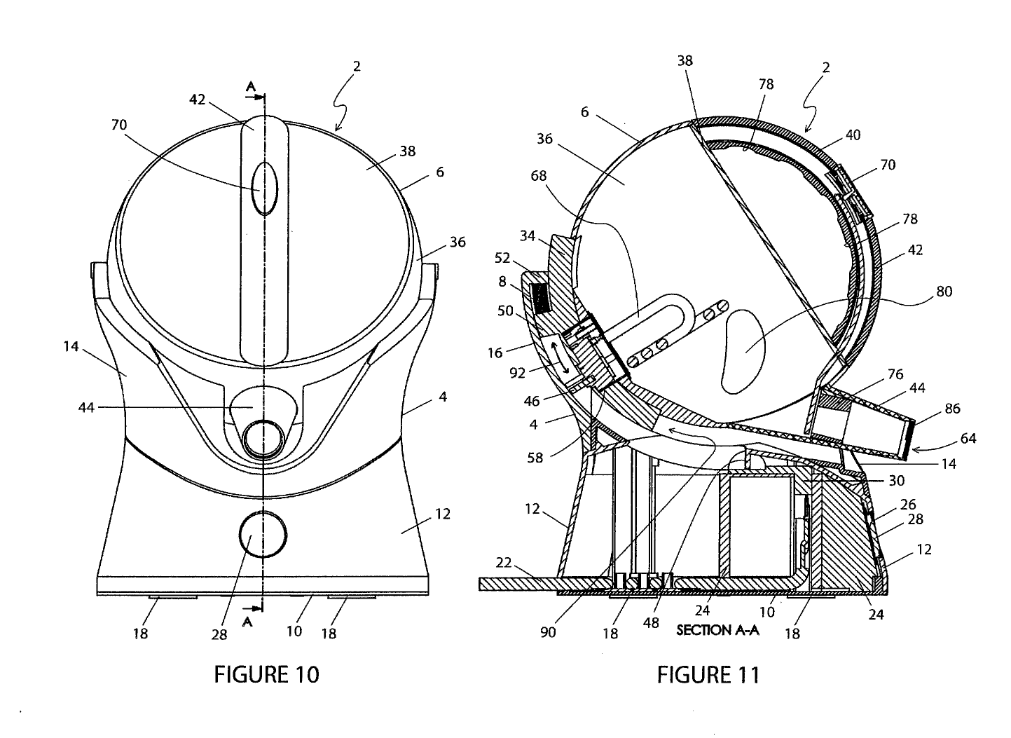

Referring to the drawings, there is shown a tea kettle, generally designated 2. The kettle comprises a base 4, a body 6 disposed on the base 4, and a return spring 8 (visible in FIGS. 7, 9, 11 and 15). As will be discussed in more detail later, the body 6 is rotatable on the base 4 between an upright or filling position (as shown in FIGS. 8, 9, 12 and 14) and a pouring position (as shown in FIGS. 10, 11 and 13).

The base 4 of the kettle 2 comprises:

a circular weighted steel bottom plate 10 with an upwardly projecting circumferential rim which defines a notch 20 at its rear;

four spaced rubber feet 18 which are fixed by screws to the underside of the bottom plate 10;

a lower base housing 12 which rests atop the bottom plate 10 and has a downwardly extending circumferential ring which engages with the rim of the bottom plate 10, the lower base housing defining a button hole 32 (see FIG. 15);

an upper base housing 14 which rests atop the lower base housing 12; and

a rear housing attachment 16 which attaches at the rear of the upper base housing 14.

The base 4 further defines a groove 92 in which return spring 8 extends (see FIGS. 9 and 11).

A cavity within the base 4, as defined by the lower base housing 12 and the bottom plate 10, houses electrical componentry. The electrical componentry comprises an electrical wire 22, an interconnecting piece 24, a printed circuit board 26, a power button 28, and power electronics 30. Wire 22 extends into the lower base housing 12 through notch 20, winds through the rear portion of interconnecting piece 24, then extends forward along the upper surface of bottom plate 10, before narrowing and passing upwardly behind the anterior portion of interconnecting piece 24. It is here that the wire 22 electrically connects with power electronics 30 which project downwardly behind the anterior portion of the interconnecting piece 24. The printed circuit board 26 is located at the front surface of the anterior portion of the interconnecting piece 24. The power button 28 spans the button hole 32 in front of the printed circuit board.

The body 6 of the kettle 2 comprises:

a curved rectangular slide piece 34, the slide piece 34 being adapted to slide within a curved channel 90 present proximate the top of base 4;

a body housing 36 which attaches to the slide piece 34;

a flat circular lid 38 which is removable from the top of the body housing 36;

a “C” shaped steel handle 40, the ends of which are fixed to the top of the lid 38 proximate opposite sides of its circumference; and

a rubberised grip 42 covering the handle 40, the under surface of grip 42 defining a series of finger grooves 78 for facilitating gripping by a user.

The body housing 36 has a pair of transparent Perspex windows 80, oppositely disposed about half way towards the front of the body housing 36. The windows 80 allow the user to visualise the water level in the chamber 62.

The slide piece 34 has a downwardly projecting abutment member 46 which is adapted to abut against a stationary blocking member 48 of the base 4 in order to prevent backwards rotation of the body and past the upright position (see FIG. 9). Further, the slide piece 34 has a downwardly projecting return member 50 which tracks in groove 92 and abuts against the front end of return spring 8, thereby compressing the return spring 8 as the slide piece 34 slides backwards during rotation of the kettle body 6 towards the filling position. The return spring 8 is compressed between the rear surface of the return member 50 and the under surface of a return bridge 52 which extends forward at the top of the rear housing attachment 16.

A circular heater recess 56 is present in the top surface of the slide piece 34 (see FIG. 15). The heater recess 56 corresponds with a heater aperture 60 present at the bottom of the body housing 36. A short tubular water seal 58 lines both the heater recess 56 and the heater aperture 60.

The body 6 further comprises an inner chamber 62 (see FIG. 15) which is enclosed by body housing 36, as well as by lid 38 from above when in place. The inner chamber 62 is adapted to contain water therein and extends into the elongate cone shaped spout 44. The spout 44 has an external opening 64.

The kettle 2 further comprises heating means for heating water in the chamber. The heating means includes the electronic componentry aforementioned, and further comprises heating electronics 66 and a heating element 68 which are interconnected and extend up through and above the water seal 58 into the inner chamber 62.

Further, the kettle 2 comprises a flow control mechanism having a safety button 70, a lever arm 72 with an enlarged square head 74, and a tubular member 76. The safety button 70 has a downward projection which is adapted to push down on an inner end of the lever arm 72 when the safety button 70 is depressed. The square head 74 is located at the outer end of the lever arm 72, adjacent to the tubular member 76 which is fitted within and communicates with the spout 44.

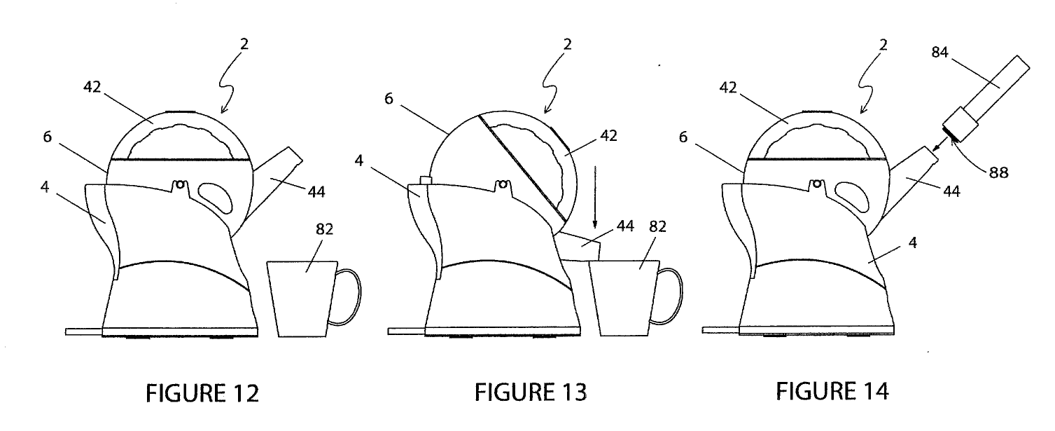

Referring now to FIG. 12, the kettle 2 is shown in the upright or filling position with a mug or cup 82 located beneath the spout 44 on a supporting surface such as a table. In order to heat water in the inner chamber 62, power button 28 is depressed by a user, thereby activating the electrical componentry which causes the heating element 68 to heat within inner chamber 62, eventually boiling water in which the heating element 68 is immersed.

Once the water is boiled, a user grips the grip handle 42 and urges it forwards. This action causes the slide piece 34 to slide backwards in the channel 90 resulting in compression of the return spring 8 by return member 50 and downward rotation of the body 6 towards the pouring position (see FIGS. 10, 11 and 13). Thus, rather than having to lift the kettle body 6 up off the base 4, carry it to the mug 82, and then hold over the mug 82 whilst tilting in order to pour boiling water out through the spout 44, the user simply urges the handle 40, 42 gently forwards so that the spout 44 rotates downwardly over the mug 82.

With the body 6 rotated down to the pouring position, the boiling water is prevented from flowing out of the inner chamber 62 through the spout 44 until the user activates the flow control mechanism 70, 72, 74, 76. Thus, in order to enable water to flow out through the spout 44 and into the mug 82, the user is required to depress safety button 70, which in turn abuts against the inner end of lever arm 72, thereby causing its square head 74 to be disengaged from the entrance of the tubular member 76 so that water is no longer blocked from flowing through the tubular member 76 and out through spout 44. Once the desired amount of water has been poured into the mug 82 from the inner chamber 62, the user releases safety button 70 so that no further water is able to flow out of the inner chamber 62. The user then enables the body 6 to return to the upright position by releasing the grip 42, thereby allowing the return spring 8 to recoil back against the return member 50 which causes the body 6 to rotate back to the upright position.

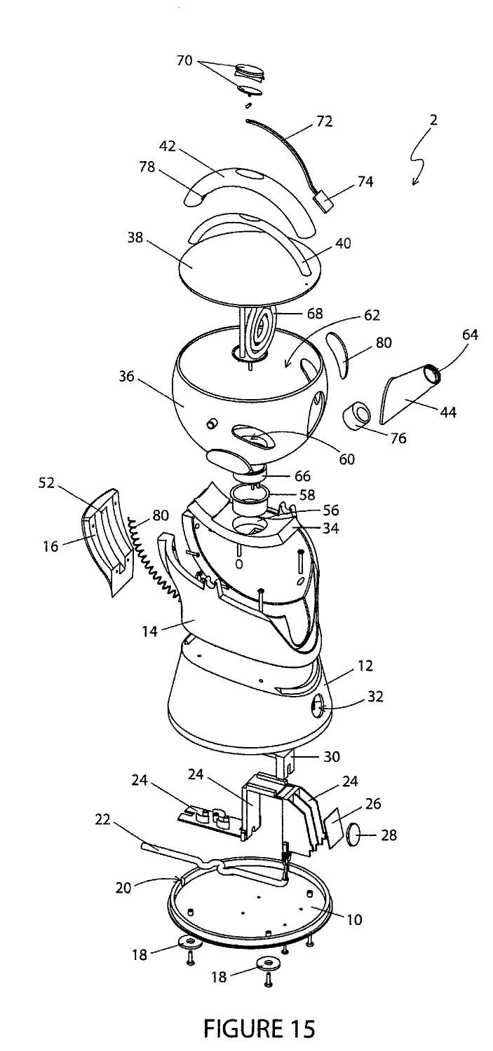

FIG. 14 shows the body 6 of the kettle 2 returned back to the upright position. In this position the kettle 2 may be filled with water by attaching one end of a hose attachment 84 to the external opening of the spout 64, and the other end of the hose attachment 84 to a tap or faucet. The external opening of the spout 64 comprises an internal thread 86 which is adapted for screwable attachment to an externally threaded fitting 88 of the hose attachment 84. With hose attachment 84 fastened, inner chamber 62 is filled by turning on the tap or faucet so that water passes through the hose attachment 84 and then through the spout 44 into the inner chamber 62. Thus, there is no need to lift the kettle 2 up off the table and carry it across to the tap for filling. However, if the user desires, the inner chamber 62 may still be filled by removing the lid 38 and lifting the body 6 of the kettle 2 across to the tap or faucet for filling.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

Finally, as the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A vessel comprising:
a base; and
a body disposed on the base, the body comprising an inner chamber adapted to hold water therein and an outlet for allowing passage of water out of the inner chamber;
wherein the body is rotatable with respect to the base between an upright position suitable for filling the inner chamber with water and a pouring position in which water may be enabled to flow out of the inner chamber through the outlet with gravity.

2. The vessel according to claim 1, wherein the body is removable from the base.

3. The vessel according to claim 1, wherein the body is adapted for rotation to the pouring position without being removed from the base.

4. The vessel according to claim 1, wherein the base comprises a channel and the body comprises a slide portion which is adapted to slide back within the channel during rotation of the body towards the pouring position.

5. The vessel according to claim 1, comprising a return mechanism which is adapted to return the body from the pouring position to the upright position without assistance from a user.

6. The vessel according to claim 5, wherein the return mechanism comprises a spring adapted to be compressed when the body is urged towards the pouring position and adapted to recoil when the body is released thereby causing the body to return to the upright position.

7. The vessel according to claim 6, wherein,
the base comprises a groove with a return bridge at its back end;
the body comprises a downwardly projecting return member which is adapted to track within the groove towards the return bridge when the body is rotated towards the pouring position; and
the spring extends within the groove between the return member and the return bridge;
wherein rotation of the body towards the pouring position is limited by compression of the spring between the return member and the return bridge.

8. The vessel according to claim 6, wherein,
the base comprises a blocking member, and
the body comprises a downwardly projecting abutment member which is adapted to abut against the blocking member in order to limit backwards rotation of the body past the upright position.

9. The vessel according to claim 1, comprising a flow control mechanism adapted for adjusting the flow of water out of the inner chamber through the outlet when the body is in the pouring position.

10. The vessel according to claim 9, wherein the flow control mechanism is adjustable between a closed configuration in which water is prevented from flowing out of the inner chamber through the outlet when the body is in the pouring position and a released configuration in which water is allowed to flow out of the inner chamber through the outlet when the body is in the pouring position.

11. The vessel according to claim 9, wherein the flow control mechanism comprises an internal flow bridge within the inner chamber proximate the outlet and a bridge control for adjusting the position of the flow bridge.

12. The vessel according to claim 11, wherein the body comprises a handle and the bridge control comprises a button disposed on the handle.

13. The vessel according to claim 1, comprising a heating mechanism for boiling water in the inner chamber.

14. The vessel according to claim 13, wherein the heating mechanism comprises:
a heating element located proximate the bottom of and within the inner chamber; and
electrical componentry located within the base, the electrical componentry being adapted for electrical interconnection between the heating element and an external power source.

15. The vessel according to claim 1, wherein the outlet is adapted for connection to one end of a hose attachment, the other end of the hose attachment being attachable to a tap or faucet.

16. The vessel according to claim 15, wherein the outlet comprises a spout with a threaded recess about its external opening, the threaded recess enabling screwable connection with the hose attachment.

17. The vessel according to claim 1, comprising a steam control mechanism for controlling the flow of steam out of the outlet during pouring.

18. The vessel according to claim 1, wherein the vessel comprises an electric tea kettle.

19. A method of using an electric tea kettle, the electric tea kettle comprising a base and a body which is rotatable on the base between a filling position and a pouring position, the method comprising the steps of:
urging the body to rotate to the pouring position without lifting the body off the base; and
releasing the body so that it automatically rotates back to the filling position.
